(19) United States
(12) Patent Application Publication
(10) Pub. No.: US 2010/0005514 A1
(43) Pub. Date: Jan. 7, 2010

(54) METHOD, SYSTEM AND SERVER FOR FILE RIGHTS CONTROL

(75) Inventor: Liangde Chen, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: CHENGDU HUAWEI SYMANTEC TECHNOLOGIES CO., LTD., Chengdu (CN)

(21) Appl. No.: 12/475,702

(22) Filed: Jun. 1, 2009

(30) Foreign Application Priority Data
Jul. 1, 2008 (CN) 200810068272.X
Mar. 30, 2009 (CN) PCT/CN2009/071077

(51) Int. Cl. G06F 21/00

(52) U.S. Cl. 726/4; 726/22; 707/9

(57) ABSTRACT

A file rights control method, a file rights control system, and a server are described. The file rights control method includes: monitoring identity information of a file author; determining at least one authorization object of the file according to identity information of the file author; determining rights corresponding to different authorization objects of the file according to the identity information of the file author and the at least one authorization object of the file; and authorizing the at least one authorization object of the file according to the determined rights corresponding to different authorization objects of the file. A file rights control system and a server are further described. By using the embodiments of the present invention, the complexity of file authorization control operation is reduced, thus improving the working efficiency of users. Moreover, the authorization of a fine granularity and a higher security are ensured.

### CROSS-REFERENCE TO RELATED APPLICATIONS

This application claims priority to International Application No. PCT/CN2009/071077, filed on Mar. 30, 2009, and Chinese Patent Application No. 200810068272.X, filed on Jul. 1, 2008, both of which are incorporated herein by reference in their entireties.

### FIELD OF THE TECHNOLOGY

The present invention relates to the field of information security technology, and more particularly to a method, a system, and a server for file rights control.

### BACKGROUND

In order to ensure the security of internal enterprise information, a file rights control system is usually deployed in the enterprise. The file rights control system generally includes a server and a client. The client is installed in the computer of every user, and may have an operational graphic interface, such as a dialog box. The client is usually configured to perform file encryption and decryption. The server is usually configured to store the user information and the authorization information about the files.

When making a file, the author (or a designated person having a reauthorization right) usually has to specify in the client program who has what kinds of rights over this file, which is referred to as authorization. The authorization has several granularities, respectively specifying right levels such as reading, editing, printing, and full control right. The designated person may be a designated individual, a designated department, or authorized according to groups.

The file rights control system aims to ensure the security of information assets inside the enterprise, and to protect files from being read by those who are not allowed to read the files.

However, due to different levels of computer skills of users in the enterprise, some may be quite confused by the complicated process of selecting authorized personnel and authorization level during the encryption of the file. Moreover, it is rather troublesome to select the personnel and right level each time a file is encrypted.

Therefore, the easy utilization of authorization of the file rights control system is critical. Many products have adopted some methods to reduce the complexity of authorization, and two methods used in the prior art are described as follows.

1. A template based authorization encryption is employed. When a user performs the authorization, the user selects the personnel and the corresponding right, and saves the selections as a template, so that the user may select the template when performing the authorization next time so as to finish the same authorization.

2. An automatic authorization encryption/decryption is employed. The right levels of the files are not distinguished, and the files made in the enterprise are all encrypted automatically. Any legal user in the enterprise network may open any encrypted file, and the encryption and decryption are performed automatically on the lower layer.

During the implementation of the present invention, the inventor found that the prior art at least has the following disadvantages.

Firstly, in the template based encryption method, the creation of a template is a quite complicated operation, which can only be used by those familiar with the operation of the computer.

Secondly, the automatic encryption/decryption sacrifices the authorization of a fine granularity, thus having a low security. This method can only protect the files from being read by those from outside the enterprise, but is unable to protect the files from being read by those inside the enterprise who are not allowed to read the files.

### SUMMARY

In order to solve the problems in the prior art that the file authorization control operation is too complicated or sacrifices the authorization of a fine granularity to result in a low security, the present invention is directed to a method, a system, and a server for file rights control.

In an embodiment of the present invention, a file rights control method is provided, which includes the following steps.

Identity information of a file author is monitored.

Authorization objects of the file are determined according to the identity information of the file author.

Rights corresponding to different authorization objects of the file are determined according to the identity information of the file author and the authorization objects of the file.

The authorization objects of the file is authorized according to the rights corresponding to different authorization objects of the file.

In an embodiment of the present invention, a file rights control method is further provided, which includes the following steps.

Identity information of a file author is monitored.

Role information of the file author is determined according to the identity information of the file author.

Authorization objects and rights corresponding to different authorization objects are determined according to the determined role information of the file author.

The authorization objects of the file are authorized according to the determined rights corresponding to different authorization objects of the file.

In an embodiment of the present invention, a file rights control system is further provided, which includes an identity monitoring unit, an authorization object determination unit, an authorization object right determination unit, and an authorization unit.

The authorization object determination unit is configured to determine authorization objects of a file according to the identity information of a file author.

The authorization object right determination unit is configured to determine rights corresponding to different authorization objects of the file according to the identity information of the file author and the authorization objects determined by the authorization object determination unit.

The authorization unit is configured to authorize the authorization objects of the file according to the rights corresponding to different authorization objects of the file determined by the authorization object right determination unit.

In an embodiment of the present invention, a file rights control system is further provided, which includes a role information determination unit, an authorization object determination unit, an authorization object right determination unit, and an authorization unit.

The role information determination unit is configured to determine role information of a file author according to the identity information of the file author

The authorization object determination unit is configured to determine authorization objects of the file according to the role information of the file author determined by the role information determination unit.

The authorization object right determination unit is configured to determine rights corresponding to the authorization objects according to the authorization objects of the file determined by the authorization object determination unit.

The authorization unit is configured to authorize the authorization objects of the file according to the authorization objects of the file determined by the authorization object determination unit and the rights corresponding to the authorization objects determined by the authorization object right determination unit.

Compared with the prior art, the embodiments of the present invention at least have the following effects. The complexity of the file authorization control operation is reduced, thus improving the working efficiency of the user and ensuring the authorization of a fine granularity and a higher security.

### BRIEF DESCRIPTION OF THE DRAWINGS

The present invention will become more fully understood from the detailed description given herein below for illustration only, and thus are not limitative of the present invention, and wherein:

FIG. 1 is a flow chart of a file rights control method according to a first embodiment of the present invention;

FIG. 2 is a flow chart of another file rights control method according to a second embodiment of the present invention;

FIG. 3 is a flow chart of another file rights control method according to a third embodiment of the present invention;

FIG. 4 is a schematic structural view of a file rights control system according to a fourth embodiment of the present invention;

FIG. 5 is a schematic structural view of a file rights control server according to a fifth embodiment of the present invention;

FIG. 6 is a schematic structural view of another file rights control system according to a sixth embodiment of the present invention; and

FIG. 7 is a schematic structural view of another file rights control server according to a seventh embodiment of the present invention

### DETAILED DESCRIPTION

In order to make the objectives, technical solutions, and advantages of the embodiments of the present invention more clearly, the technical solutions in the embodiments of the present invention will be described in detail below with the accompanying drawings. It should be noted that, the embodiments described herein are just a part of the embodiments of the present invention, and the other embodiments obtained by those of ordinary skill in the art based on the embodiments of the present invention without making any creative efforts all fall within the scope of the invention.

In the following embodiments, a file rights control system may be configured in an operating system such as Windows, Unix, and Linux, and the file may be an office file, a PDF file, or files of other formats. The algorithm of encrypting the file may be various types of encryption algorithms. The authorization rights include read only, editing, printing, full control, and the like.

### Embodiment 1

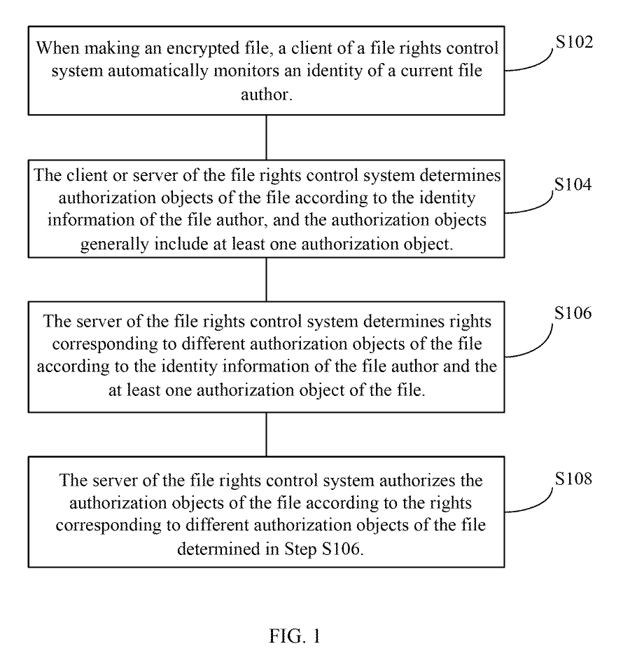

As shown in FIG. 1, a file rights control method according to an embodiment of the present invention includes the following steps.

In Block S102, when making an encrypted file, a client of the file rights control system automatically monitors identity information of a current file author.

In this embodiment, the identity information may include information about the department, the group, or the role of the file author.

In Block S104, the client or server of the file rights control system determines authorization objects of the file according to the identity information of the file author, and the authorization objects generally include at least one authorization object.

In Block S106, the server of the file rights control system determines rights corresponding to different authorization objects of the file according to the identity information of the file author and the at least one authorization object of the file.

In Block S108, the server of the file rights control system authorizes the authorization objects of the file according to the rights corresponding to different authorization objects of the file determined in Block S106.

In this embodiment, the authorization may be totally automatic, and even no dialog box prompts at the client. For example, when a user edits a file with the Word software and clicks the Save button, the client of the file rights control system detects this saving action, automatically obtains the identity information of the file author and obtains the information about the authorization object, and then automatically performs encryption authorization on the file. In this manner, the user may hardly feel the file rights control system.

By using this embodiment, the information about the authorization objects may be obtained through automatically monitoring the identity information of the current file author, and the encryption authorization is performed on the file automatically, thus realizing the automatization of the file authorization control operation. Therefore, the complexity of the file authorization control operation is reduced, thus improving the working efficiency of the user and ensuring a higher security.

### Embodiment 2

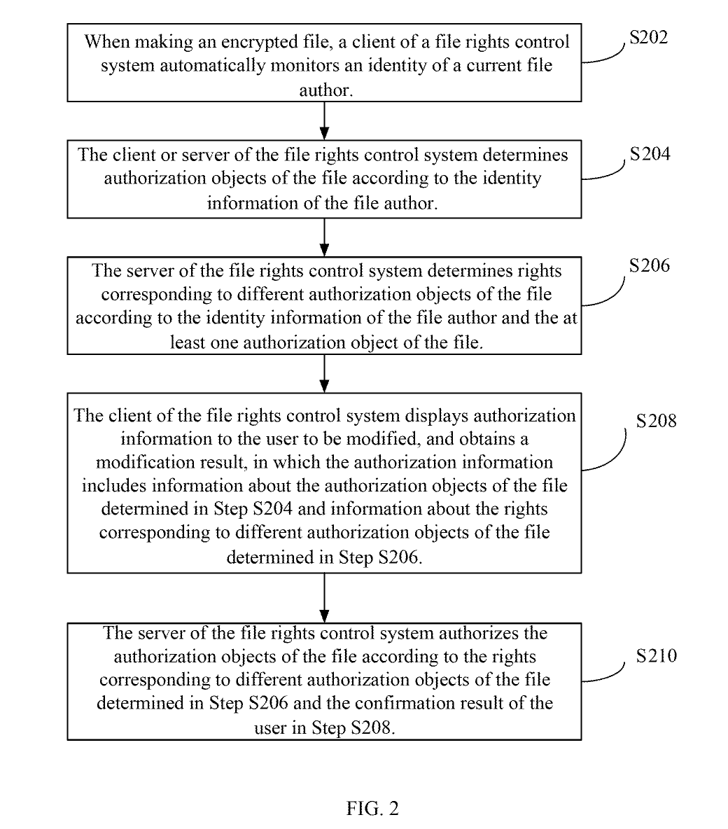

As shown in FIG. 2, a file rights control method according to an embodiment of the present invention includes the following steps.

In Block S202, when making an encrypted file, the client of the file rights control system automatically monitors identity information of a current file author.

In this embodiment, the identity information may include information about the department, the group, or the role of the file author.

In Block S204, the client or server of the file rights control system determines authorization objects of the file according to the identity information of the file author, and the authorization objects generally include at least one authorization object.

In Block S206, the server of the file rights control system determines rights corresponding to different authorization objects of the file according to the identity information of the file author and the at least one authorization object of the file.

In Block S208, the client of the file rights control system displays authorization information to the user to be modified, and obtains a modification result. The authorization information includes information about the authorization objects of the file determined in Block S204 and information about the rights corresponding to different authorization objects of the file determined in Block S206.

In this step, the modification performed by the user may include adding or deleting the information about the authorization objects and the information about the rights corresponding to the authorization objects, or modifying the right of a particular authorization object in special cases, or directly confirming without any modification, and the like.

In Block S210, the server of the file rights control system authorizes the authorization objects of the file according to the rights corresponding to different authorization objects of the file determined in Block S206 and the confirmation result of the user in Block S208.

In this step, the confirmation result of the user may be that the authorization information about the file rights control system is fully accepted by the user, or that the authorization information is added, deleted, or modified by the user, the authorization information including the authorization objects, corresponding rights, and so on.

In this embodiment, for example, when a user edits a file with the Word software and clicks the Save button, the client detects this saving action, automatically obtains the identity information of the file author and obtains an authorization list, and then a dialog box prompts for the user to select the authorization information. A default authorization list of the identity has already been listed in the dialog box, and in most circumstances, the user only has to click OK to perform the selection. In some special cases, the user may add or delete some authorization information before clicking OK.

By using this embodiment, the information about the authorization objects may be obtained and displayed to the user to be confirmed through automatically monitoring the identity information of the current file author, and the encryption authorization is performed on the file automatically. Therefore, the complexity of the file authorization control operation is reduced, thus improving the working efficiency of the user and ensuring the authorization of a fine granularity and a higher security.

### Embodiment 3

A user may play several roles at the same time. For example, a software developer may serve as a file manager of a project team. The authorizations to files issued by the user in different roles are also different.

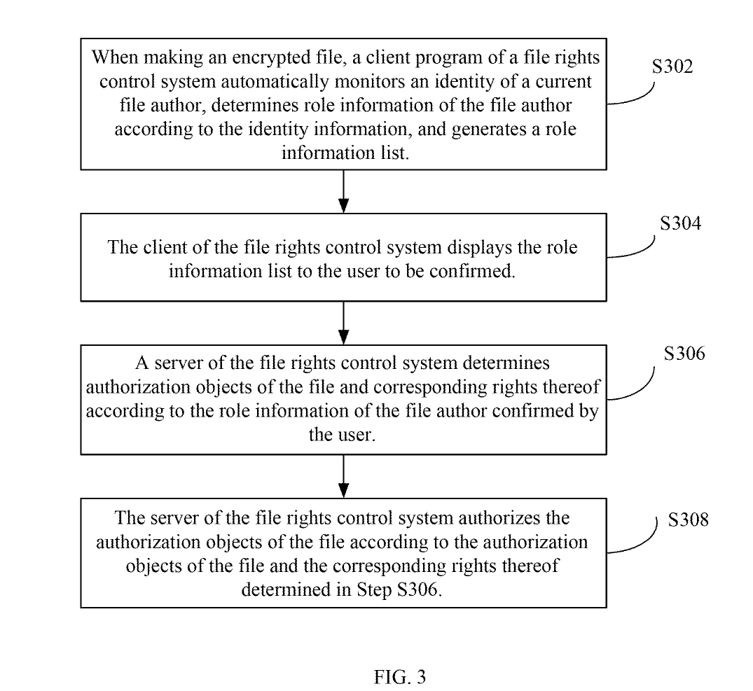

As shown in FIG. 3, a file encryption method according to the embodiment of the present invention includes the following steps.

In Block S302, when making an encrypted file, a client of the file rights control system automatically monitors the identity information about the current file author, determines role information of the file author according to the identity information, and generates a role information list. The role information may include information about the department, the group, and the corresponding role of the file author.

In Block S304, the client of the file rights control system displays the role information list to the user to be selected and confirmed.

After this step, the confirmation performed by the user may be selecting one or more roles from a plurality of roles in the role information list, and the like.

In Block S306, the server of the file rights control system obtains the role information of the file author selected and confirmed by the user, and determines the authorization objects of the file and the corresponding rights thereof according to the role information of the file author selected and determined by the user.

In Block S308, the server of the file rights control system authorizes the authorization objects of the file according to the authorization objects of the file and the corresponding rights thereof determined in Block S306.

The user selects one or more roles from the plurality of roles, and the system generates a suitable authorization list according to the roles selected by the user, so as to perform authorization on the file. For example, when the user edits a file in the Word and clicks the Save button, the client detects the saving action, automatically obtains the identity information of the user, and finds that the user is a member of an ABC project team and plays two roles including software developer and file manager. The client of the file rights control system enables the user to select the role for this authorization, and if the user selects the software developer, the client automatically authorizes the file according to configuration information about the system. That is, all the members in the ABC project team have a read right of the file, and the project manager of the ABC project team has an editing right of the file. If the user selects the role of the file manager, the client automatically authorizes the read only and editing rights of the file to all the members in the ABC project team according to the configuration information about the system.

By using this embodiment, the role information of the file author may be obtained and displayed to the user to be confirmed through automatically monitoring the identity information of the current file author, and the encryption authorization is performed on the file automatically. Therefore, the complexity of the file authorization control operation is reduced, thus improving the working efficiency of the user and ensuring the authorization of a fine granularity and a higher security.

### Embodiment 4

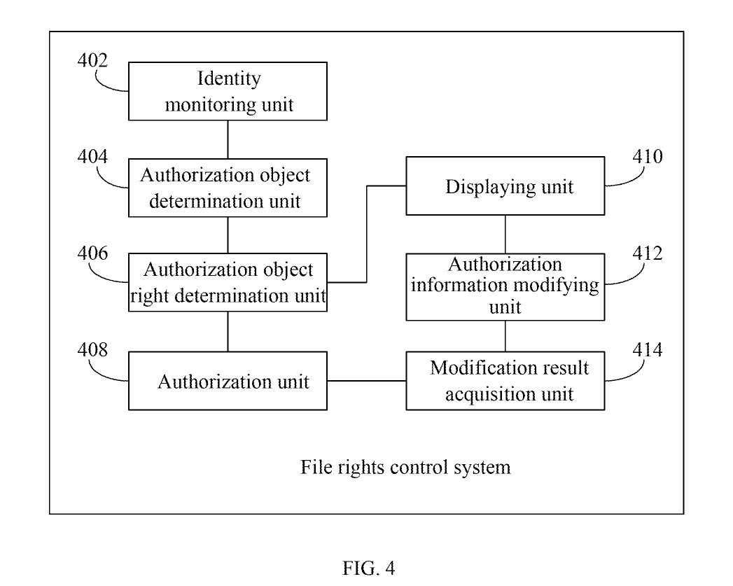

As shown in FIG. 4, a file rights control system is provided in this embodiment, which includes an identity monitoring unit 402, an authorization object determination unit 404, an authorization object right determination unit 406, and an authorization unit 408. The above units may be configured in the client or the server of the file rights control system according to actual requirements.

The identity monitoring unit 402 is configured to automatically monitor the identity information of a current file author when encrypting a file.

The authorization object determination unit 404 is configured to determine authorization objects of the file according to the identity information of the file author monitored by the identity monitoring unit 402.

The authorization object right determination unit 406 is configured to determine rights corresponding to different authorization objects of the file according to the identity information of the file author and at least one authorization object of the file determined by the authorization object determination unit 404.

The authorization unit 408 is configured to authorize the authorization objects of the file according to the rights corresponding to different authorization objects of the file determined by the authorization object right determination unit 406.

Further, the file rights control system also includes a displaying unit 410, an authorization information modifying unit 412, and a modification result acquisition unit 414. The above units may be configured in the client or the server of the file rights control system according to actual requirements.

The displaying unit 410 is configured to display authorization information to a user to be confirmed, and the authorization information includes information about the authorization objects of the file determined by the authorization object determination unit 404 and information about the rights corresponding to different authorization objects of the file determined by the authorization object right determination unit 406.

The authorization information modifying unit 412 is configured to modify the authorization information displayed by the displaying unit 410. The authorization information includes information about the authorization objects of the file determined by the authorization object determination unit 404 and information about the rights corresponding to different authorization objects of the file determined by the authorization object right determination unit 406. The modification includes adding, deleting, or amending the information about the authorization objects and the information about the rights corresponding to the authorization objects, or directly confirming without any modification, and so on.

The modification result acquisition unit 414 is configured to acquire a modification result of the authorization information modifying unit 412.

When the file rights control system includes the displaying unit 410, the authorization information modifying unit 412, and the modification result acquisition unit 414, the authorization unit 408 is further configured to authorize the authorization objects of the file according to the rights corresponding to different authorization objects of the file determined by the authorization object right determination unit 406 and the modification result obtained by the modification result acquisition unit 414.

By using this embodiment, the complexity of the file authorization control operation is reduced, thus improving the working efficiency of the user and ensuring the authorization of a fine granularity and a higher security.

### Embodiment 5

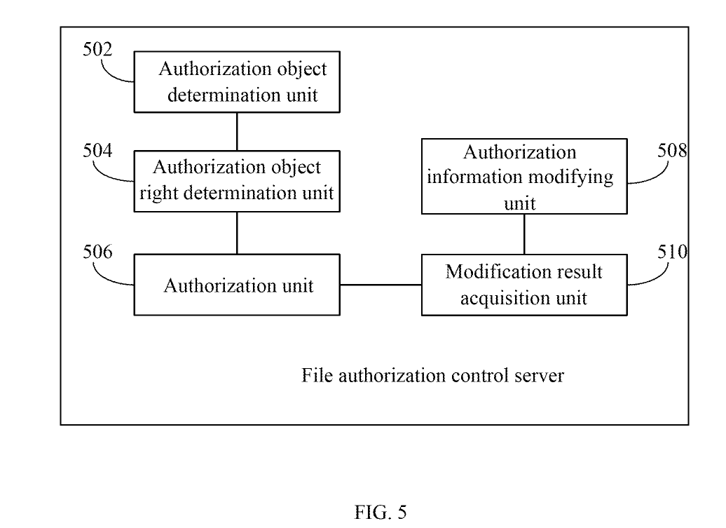

As shown in FIG. 5, a file rights control server is provided in this embodiment, which includes an authorization object determination unit 502, an authorization object right determination unit 504, and an authorization unit 506.

The authorization object determination unit 502 is configured to determine authorization objects of the file according to identity information of a file author monitored by a client.

The authorization object right determination unit 504 is configured to determine rights corresponding to different authorization objects of the file according to the identity information of the file author and at least one authorization object of the file determined by the authorization object determination unit 502.

The authorization unit 506 is configured to authorize the authorization objects of the file according to the rights corresponding to different authorization objects of the file determined by the authorization object right determination unit 504.

Further, the file encryption server further includes an authorization information modifying unit 508 and a modification result acquisition unit 510.

The authorization information modifying unit 508 is configured to modify the authorization information according to modification instructions from the user of the client. The authorization information includes information about authorization objects of the file determined by the authorization object determination unit 502 and information about the rights corresponding to different authorization objects of the file determined by the authorization object right determination unit 504. The modification includes adding, deleting, or amending the information about the authorization objects and the information about the rights corresponding to the authorization objects, or directly confirming without any modification, and so on.

The modification result acquisition unit 510 is configured to acquire a modification result of the authorization information modifying unit 508.

When the file encryption server includes the authorization information modifying unit 508 and the modification result acquisition unit 510, the authorization unit 506 is further configured to authorize the authorization objects of the file according to the rights corresponding to different authorization objects of the file determined by the authorization object right determination unit 504 and the modification result obtained by the modification result acquisition unit 510.

By using this embodiment, the complexity of the file authorization control operation is reduced, thus improving the working efficiency of the user and ensuring the authorization of a fine granularity and a higher security.

### Embodiment 6

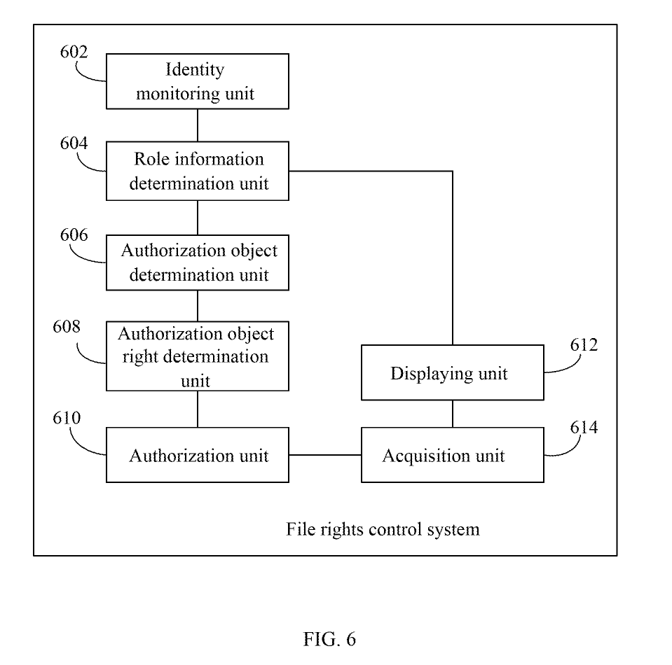

As shown in FIG. 6, a file rights control system is provided in this embodiment, which includes an identity monitoring unit 602, a role information determination unit 604, an authorization object determination unit 606, an authorization object right determination unit 608, and an authorization unit 610. The above units may be configured in the client or server of the file rights control system according to actual requirements.

The identity monitoring unit 602 is configured to automatically monitor the identity information of a current file author when encrypting a file.

The role information determination unit 604 is configured to determine role information of the file author according to the identity information of the file author monitored by the identity monitoring unit 602.

The authorization object determination unit 606 is configured to determine authorization objects of the file according to the role information of the file author determined by the role information determination unit 604.

The authorization object right determination unit 608 is configured to determine rights corresponding to the authorization objects according to the authorization objects of the file determined by the authorization object determination unit 606.

The authorization unit 610 is configured to authorize the authorization objects of the file according to the authorization objects of the file determined by the authorization object determination unit 606 and the rights corresponding to the authorization objects determined by the authorization object right determination unit 608.

Further, when the file author plays several roles at the same time, the role information determination unit 604 is also configured to determine the role information of the file author according to the identity information of the file author monitored by the identity monitoring unit 602, so as to generate a role information list.

The file rights control system further includes a displaying unit 612 and an acquisition unit 614.

The displaying unit 612 is configured to display the role information list generated by the role information determination unit 604 to the user to be selected and confirmed.

The acquisition unit 614 is configured to acquire the role information of the file author selected and determined by the user.

The authorization object determination unit 606 is further configured to determine the authorization objects of the file according to the role information of the file author obtained by the acquisition unit 614.

By using this embodiment, the complexity of the file authorization control operation is reduced, thus improving the working efficiency of the user and ensuring the authorization of a fine granularity and a higher security.

### Embodiment 7

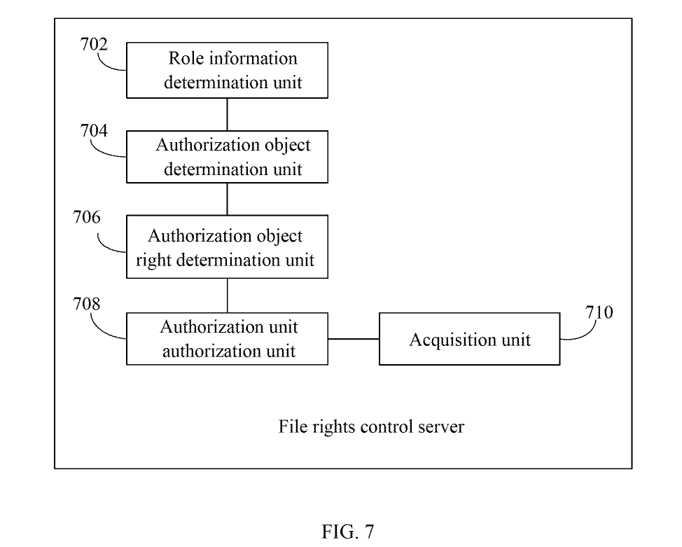

As shown in FIG. 7, a file rights control server is provided in this embodiment, which includes a role information determination unit 702, an authorization object determination unit 704, an authorization object right determination unit 706, and an authorization unit 708.

The role information determination unit 702 is configured to determine role information of a file author according to identity information of the file author monitored by a client.

The authorization object determination unit 704 is configured to determine authorization objects of the file according to the role information of the file author determined by the role information determination unit 702.

The authorization object right determination unit 706 is configured to determine rights corresponding to the authorization objects according to the authorization objects of the file determined by the authorization object determination unit 704.

The authorization unit 708 is configured to authorize the authorization objects of the file according to the authorization objects of the file determined by the authorization object determination unit 704 and the rights corresponding to the authorization objects determined by the authorization object right determination unit 706.

Further, when the file author plays several roles at the same time, the role information determination unit 702 is also configured to determine the role information of the file author according to the identity information of the file author monitored by the client, so as to generate a role information list.

The file rights control server further includes an acquisition unit 710, which is configured to acquire the role information of the file author selected and determined by the client user according to the role information list determined by the role information determination unit 702.

The authorization object determination unit 704 is further configured to determine the authorization objects of the file according to the role information of the file author obtained by the acquisition unit 710.

By using this embodiment, the complexity of the file authorization control operation is reduced, thus improving the working efficiency of the user and ensuring the authorization of a fine granularity and a higher security.

In view of the above, by using the embodiments, the automatization of file authorization control operation is realized, thus reducing the complexity of the file authorization control operation, improving the working efficiency of the user, and ensuring the authorization of a fine granularity and a higher security.

The units and algorithm steps in the embodiments of the present invention may be realized by electronic hardware, computer software, or a combination of the two. In order to clearly illustrate the exchangeability of the hardware and the software, the composition and steps of the embodiments have been generally described above according to the functions. Whether these functions are executed through hardware or software depends on special applications and design restrictions of the technical solutions. Those skilled in the art may implement the described functions by using different methods for different specific applications, and the implementation should not be considered as beyond the scope of the invention.

The steps of the methods or algorithms described in the embodiments of the present invention may be implemented through hardware, software modules executed by a processor, or a combination of the two. The software modules may be configured in a random rights memory (RAM), an internal memory, a read only memory (ROM), an electrically programmable ROM, an electrically erasable and programmable ROM, a register, a hard disk, a mobile disk, a CD-ROM, or a storage medium of any other forms.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A file rights control method, comprising:
monitoring identity information of a file author;
determining authorization objects of the file according to the identity information of the file author;
determining rights corresponding to different authorization objects of the file according to the identity information of the file author and the authorization objects of the file; and
authorizing the authorization objects of the file according to the determined rights corresponding to different authorization objects of the file.

2. The file rights control method according to claim 1, wherein before authorizing the authorization objects of the file according to the determined rights corresponding to different authorization objects of the file, the method further comprises:
displaying authorization information to a user to be modified, wherein the authorization information comprises information about the authorization objects of the file and information about the rights corresponding to different authorization objects of the file; and
obtaining a modification result.

3. The file rights control method according to claim 2, wherein the authorizing the authorization objects of the file according to the determined rights corresponding to different authorization objects of the file comprises:
authorizing the authorization objects of the file according to the determined rights corresponding to different authorization objects of the file and the obtained modification result.

4. A file rights control method, comprising:
monitoring identity information of a file author;
determining role information of the file author according to the identity information of the file author;
determining authorization objects of the file and rights corresponding to different authorization objects according to the determined role information of the file author; and
authorizing the authorization objects of the file according to the determined rights corresponding to different authorization objects of the file.

5. The file rights control method according to claim 4, wherein the determining the role information of the file author according to the identity information of the file author comprises:
displaying the determined role information of the file author to a user to be selected and confirmed; and
obtaining the role information of the file author selected and determined by the user.

6. A file rights control system, comprising:
an authorization object determination unit, configured to determine authorization objects of a file according to identity information of a file author;
an authorization object right determination unit, configured to determine rights corresponding to different authorization objects of the file according to the identity information of the file author and authorization objects of the file determined by the authorization object determination unit; and
an authorization unit, configured to authorize the authorization objects of the file according to the rights corresponding to different authorization objects of the file determined by the authorization object right determination unit.

7. The file rights control system according to claim 6, further comprising:
an identity monitoring unit, configured to monitor the identity information of the file author;
a displaying unit, configured to display authorization information to a user to be modified, wherein the authorization information comprises information of the authorization objects of the file determined by the authorization object determination unit and information of the rights corresponding to different authorization objects of the file determined by the authorization object right determination unit;
an authorization information modifying unit, configured to modify the authorization information displayed by the displaying unit or directly confirm the authorization information displayed by the displaying unit without any modification, wherein the modification comprises adding, deleting, or amending the information about the authorization objects and the information about the rights corresponding to the authorization objects; and
a modification result acquisition unit, configured to acquire a modification result of the authorization information modifying unit.

8. The file rights control system according to claim 7, wherein the authorization unit is further configured to authorize the authorization objects of the file according to the rights corresponding to different authorization objects of the file determined by the authorization object right determination unit and the modification result acquired by the modification result acquisition unit.

9. The file rights control system according to claim 6, wherein the identity information of the file author is monitored by a client, and the file rights control system further comprises:
an authorization information modifying unit, configured to modify authorization information according to an instruction from the client, wherein the authorization information comprises information about authorization objects of the file determined by the authorization object determination unit and information about the rights corresponding to different authorization objects of the file determined by the authorization object right determination unit; and
a modification result acquisition unit, configured to acquire a modification result of the authorization information modifying unit.

10. The file rights control system according to claim 9, wherein the authorization unit is further configured to authorize the authorization objects of the file according to the rights corresponding to different authorization objects of the file determined by the authorization object right determination unit and the modification result obtained by the modification result acquisition unit.

11. A file rights control system, comprising:
a role information determination unit, configured to determine role information of a file author according to identity information of the file author;
an authorization object determination unit, configured to determine authorization objects of the file according to the role information of the file author determined by the role information determination unit;
an authorization object right determination unit, configured to determine rights corresponding to the authorization objects according to the authorization objects of the file determined by the authorization object determination unit; and
an authorization unit, configured to authorize the authorization objects of the file according to the authorization objects of the file determined by the authorization object determination unit and the rights corresponding to the authorization objects determined by the authorization object right determination unit.

12. The file rights control system according to claim 11, further comprising:
an identity monitoring unit, configured to monitor the identity information of the file author;
a displaying unit, configured to display the role information of the file author determined by the role information determination unit to a user to be selected and confirmed; and
an acquisition unit, configured to acquire the role information of the file author selected and determined by the user,

13. The file rights control system according to claim 12, wherein the authorization object determination unit is further configured to determine the authorization objects of the file according to the role information of the file author obtained by the acquisition unit.

14. The file rights control server according to claim 11, wherein the identity information of the file author is monitored by a client, and file rights control server further comprises:
an acquisition unit, configured to acquire the role information of the file author selected and determined by the client.

15. The file rights control server according to claim 14, wherein the authorization object determination unit is further configured to determine the authorization objects of the file according to the role information of the file author obtained by the acquisition unit.
